(19) United States
(12) Patent Application Publication
(10) Pub. No.: US 2021/0292638 A1
(43) Pub. Date: Sep. 23, 2021

(54) Breaker System for Emulsified Fluid System

(71) Applicant: Halliburton Energy Services, Inc., Houston, TX (US)

(72) Inventors: Prashant D. Chopade, Kingwood, TX (US); Rajender Salla, Pune (IN); Eli Allen Schnoor, Kingwood, TX (US); Monica Rajendra Dandawate, Pune (IN); Walter T. Stephens, Houston, TX (US)

(73) Assignee: Halliburton Energy Services, Inc., Houston, TX (US)

(21) Appl. No.: 16/461,771

(22) PCT Filed: Dec. 31, 2016
(86) PCT No.: PCT/US2016/069653

§ 371 Date: May 16, 2019

(51) Int. Cl. C09K 8/68; C09K 8/60; C09K 8/70; C09K 8/80; E21B 43/267

(52) U.S. Cl. CPC C09K 8/68; C09K 8/602; C09K 2208/26; C09K 8/80; E21B 43/267; C09K 8/706

(57) ABSTRACT

A method of treating in a subterranean formation including combining a demulsifier; proppant; an emulsifier; an oil base fluid; and aqueous base fluid to form an oil-external emulsified fluid; and introducing the oil-external emulsified fluid into the subterranean formation. A method of forming a wellbore fluid including combining proppant; a demulsifier; an aqueous base fluid, an oil base fluid, and an emulsifier to form a pre-emulsified fluid; and mixing the pre-emulsified fluid to form an oil-external emulsified fluid.

### BACKGROUND

The present invention generally relates to the use of breakers in subterranean operations, and, more specifically, to oil-external emulsified fluid systems with demulsifiers, and methods of using these fluid systems in subterranean operations.

Subterranean wells (e.g., hydrocarbon fluid producing wells and water producing wells) are often stimulated by hydraulic fracturing treatments. In a typical hydraulic fracturing treatment, a treatment fluid is pumped into a wellbore in a subterranean formation at a rate and pressure above the fracture gradient of the particular subterranean formation so as to create or enhance at least one fracture therein. Particulate solids (e.g., graded sand, bauxite, ceramic, nut hulls, and the like), or “proppant particulates,” are typically suspended in the treatment fluid or a second treatment fluid and deposited into the fractures while maintaining pressure above the fracture gradient. The proppant particulates are generally deposited in the fracture in a concentration sufficient to form a tight pack of proppant particulates, or “proppant pack,” which serves to prevent the fracture from fully closing once the hydraulic pressure is removed. By keeping the fracture from fully closing, the interstitial spaces between individual proppant particulates in the proppant pack form conductive pathways through which produced fluids may flow.

In traditional hydraulic fracturing treatments, the specific gravity of the proppant particulates may be high in relation to the treatment fluids in which they are suspended for transport and deposit in a target interval (e.g., a fracture). Therefore, the proppant particulates may settle out of the treatment fluid and fail to reach the target interval. For example, where the proppant particulates are to be deposited into a fracture, the proppant particulates may settle out of the treatment fluid and accumulate only or substantially at the bottommost portion of the fracture, which may result in complete or partial occlusion of the portion of the fracture where no proppant particulates have collected (e.g., at the top of the fracture). As such, fracture conductivity and production over the life of a subterranean well may be substantially impaired if proppant particulates settle out of the treatment fluid before reaching their target interval within a subterranean formation.

Oftentimes, after the treatment fluid has performed its intended task, it may be desirable to reduce its viscosity (e.g., “break” the fluid or gel) so that the treatment fluid can be recovered from the formation and/or particulate material may be dropped out of the treatment fluid at a desired location within the formation. Breakers can be generally employed to reduce the viscosity of treatment fluids. Unfortunately, traditional breakers may result in an incomplete and/or premature viscosity reduction. Premature viscosity reduction is undesirable as it may lead to, inter alia, particulate material settling out of the fluid in an undesirable location and/or at an undesirable time. Alternately, encapsulated breakers may be used to control the release rate of breaker. However, such option adds to material costs.

Prior attempts aimed at preventing proppant settling in a vertical fracture have focused on creating proppant with density less than or equal to that of the carrier fluid. The methods of creating neutrally buoyant proppant includes surface-sealing of porous ceramic particles to trap air-filled voids inside the particles, creating composites of strong materials and hollow ceramic spheres, and creating hollow spheres with sufficient wall strength to withstand closure stresses. Polymer composite has also been used to make lightweight proppant. These approaches have characteristic drawbacks in terms of proppant durability and cost to manufacture.

Emulsified fluid systems have been proposed to increase proppant suspension time; however, these fluids have been challenging to break in a controlled manner. In many cases, treatment fluids can be utilized in an emulsified state when performing a treatment operation. For example, in a fracturing operation, a treatment fluid can be emulsified to improve its ability to carry a proppant or other particulate material. In other cases, an emulsified treatment fluid can be used to temporarily divert or block the flow of fluids within at least a portion of a subterranean formation. In the case of fracturing operations, the emulsified treatment fluid typically spends only a very short amount of time downhole before the emulsion is broken and the treatment fluid is produced from the wellbore. In fluid diversion or blocking operations, the emulsion typically needs to remain in place only for a short amount of time while another treatment fluid is flowed elsewhere in the subterranean formation.

When conducting subterranean operations, it can sometimes become necessary to block the flow of fluids in the subterranean formation for a prolonged period of time, typically for at least about one day or more. In some cases, the period of time can be much longer, days or weeks. For example, it can sometimes be desirable to impede the flow of formation fluids for extended periods of time by introducing a kill pill or perforation pill into the subterranean formation to at least temporarily cease the communication between wellbore and reservoir. As used herein, the terms “kill pill” and “perforation pill” refer to a small amount of a treatment fluid introduced into a wellbore that blocks the ability of formation fluids to flow into the wellbore. In fluid loss applications, it can sometimes be desirable to form a barrier within the wellbore that persists for an extended period of time.

For subterranean operations requiring extended downhole residence times, many emulsion treatment fluids can prove unsuitable since they can break before their intended downhole function is completed. The premature break of emulsifed treatment fluids can be particularly problematic in high temperature subterranean formations (e.g., formations having a temperature of about 275° F. or above), where the elevated formation temperature decreases stability and speeds decomposition. As subterranean operations are being conducted in deeper wellbores having ever higher formation temperatures, the issues with long-term emulsion stability are becoming an increasingly encountered issue as existing emulsions are being pushed to their chemical and thermal stability limits.

Traditionally, the decomposition of emulsions into lower viscosity fluids may be accomplished by using a breaker and an external breaker may be needed to remove a fracturing fluid upon well completion. Breaker compounds useful in high temperature formations may have high corrosion rates and may be harmful to the formation. Controlled breaking of these fluid systems is challenging, and thus there is a need for a system allowing the consistent controlled breaking of emulsion based fracturing fluids.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIGS. 1A-C depict the problems with proppant suspension stages in vertical fractures.

FIG. 2 depicts an embodiment of a system configured for delivering the emulsion fluids of the embodiments described herein to a downhole location.

FIGS. 3A-D are photographs of proppant suspensions over time including a demulsifier in the emulsion fluid systems of the disclosure.

FIG. 4 is a photograph of a proppant suspension after 1 hour with a breaker using a high gel-loading fluid.

### DETAILED DESCRIPTION

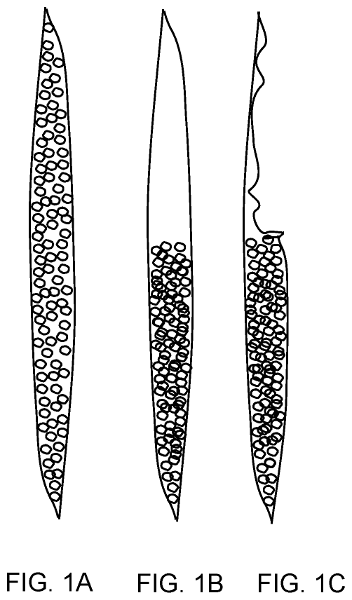

Embodiments of the invention are directed to oil-external emulsion fluid systems including a demulsifier, an aqueous base fluid, an emulsifier, and an oil base fluid system useful where controlled breaking the emulsified fluid in a time-delayed manner is desired. Proppant transport inside a hydraulic fracture has two components when the fracture is being generated. The horizontal component is dictated by the fluid velocity and associated streamlines which help carry proppant to the tip of the fracture. The vertical component is governed by the particle settling velocity of the proppant and is a function of proppant diameter and density as well as fluid viscosity and density. FIGS. 1A-C demonstrate the various proppant suspension stages in vertical fracture. FIG. 1A depicts the fracture after the completion of pumping proppant slurry. FIG. 1B shows the vertical distribution of the proppants during shut-in time, followed by FIG. 1C, the structure after fracture closure.

A common production stimulation operation that employs an emulsified treatment fluid is hydraulic fracturing. Hydraulic fracturing operations generally involve pumping a treatment fluid (e.g., a fracturing fluid) into a well bore that penetrates a subterranean formation at a sufficient hydraulic pressure to create or enhance one or more cracks, or “fractures,” in the subterranean formation. The fracturing fluid may comprise particulates, often referred to as “proppant particulates,” that are deposited in the fractures. The proppant particulates function, inter alia, to prevent the fractures from fully closing upon the release of hydraulic pressure, forming conductive channels through which fluids may flow to the well bore. Once at least one fracture is created and the proppant particulates are substantially in place, the viscosity of the fracturing fluid usually is reduced (i.e., “breaking” the fluid), and the fracturing fluid may be recovered from the formation. The term “break” and its derivatives, as used herein, refer to a reduction in the viscosity of a fluid, e.g., by the breaking or reversing of the crosslinks between polymer molecules in the fluid, or breaking chemical bonds of gelling agent polymers in the fluid. No particular mechanism is implied by the term.

A fracture having open channels throughout the fracture can be formed by contacting the subterranean formation with a pad fluid at a sufficient pressure to fracture the subterranean formation, injecting the pad fluid into the fracture at a sufficient rate to open the fracture to a sufficient width to accept suitable solids for holding the fracture open, injecting alternating quantities of displacement liquid and carrier liquid having the suitable solids supported therein into the fracture at a sufficient rate to extend the fracture into the subterranean formation, and reducing the rate of injecting the liquids into the fracture to below the rate required for holding the fracture open, thereby permitting the fracture to close on the suitable solids. A fracture formed by this method is held open by intermittent zones of solids spaced throughout the fracture.

Pad fluids are typically viscous liquids, gelled liquids, emulsions; liquid hydrocarbons and water. Proppants are typically not present in pad fluids. In some embodiments, after the pad fluid treatment, proppant particles may be added to a fluid, of similar composition to the pad fluid, to form a slurry that is pumped into the fracture to prevent it from closing when the pumping pressure is released.

### General Measurement Terms and Definitions

Unless otherwise specified or unless the context others wise clearly requires, any ratio or percentage means by volume.

If there is any difference between U.S. or Imperial units, U.S. units are intended.

Unless otherwise specified, mesh sizes are in U.S. Standard Mesh.

The micrometer (μm) may sometimes be referred to herein as a micron.

The conversion between pound per gallon (lb/gal or ppg) and kilogram per cubic meter (kg/m³) is: 1 lb/gal=(1 lb/gal)×(0.4536 kg/lb)×(gal/0.003785 m³)=119.8 kg/m³.

As used herein, into a subterranean formation can include introducing at least into and/or through a wellbore in the subterranean formation. According to various techniques known in the art, equipment, tools, or well fluids can be directed from a wellhead into any desired portion of the wellbore. Additionally, a well fluid can be directed from a portion of the wellbore into the rock matrix of a zone.

Broadly, a zone refers to an interval of rock along a wellbore that is differentiated from surrounding rocks based on hydrocarbon content or other features, such as perforations or other fluid communication with the wellbore, faults, or fractures. A treatment usually involves introducing a treatment fluid into a well. As used herein, a treatment fluid is a fluid used in a treatment. Unless the context otherwise requires, the word treatment in the term “treatment fluid” does not necessarily imply any particular treatment or action by the fluid. If a treatment fluid is to be used in a relatively small volume, for example less than about 200 barrels, it is sometimes referred to in the art as a slug or pill. As used herein, a treatment zone refers to an interval of rock along a wellbore into which a treatment fluid is directed to flow from the wellbore. Further, as used herein, into a treatment zone means into and through the wellhead and, additionally, through the wellbore and into the treatment zone.

As used herein, the term “controlled breaking” generally refers to methods of breaking in which breaking of fracturing fluid has been delayed at least for about an hour. Controlled breaking may occur in a variety of ways. For example, the kinetic rate of breaking may be delayed (e.g., by controlling temperature and/or concentration) or preferably, the release of a breaker may be delayed (i.e., controlled release of a breaker encapsulated by an encapsulant). The encapsulants are essentially protective coatings that are thermally stable and do not readily degrade until required. The nature (e.g., length) of the delay will depend largely on the specific breaker, the encapsulant and concentration used. The controlled release of breakers may occur through a number of mechanisms involving the removal of encapsulant including, but are not limited to, degradation, biodegradation, salvation, and the like. In some cases, the release of breaker may also occur by diffusion without removal of encapsulant. In some cases, the delay may correspond to a certain event (e.g., once fracturing fluid is spent) at which point a reduction in viscosity may be desirable.

In certain embodiments of the present invention, a method of treating in a subterranean formation comprises: combining a demulsifier;

an emulsifier; an oil base fluid; and aqueous base fluid to form an oil-external emulsified fluid; and introducing the oil-external emulsified fluid into the subterranean formation. The combining step may further include a proppant. The demulsifers may include nonionic microemulsions.

The methods and fluids described herein may result in improved controlled breakers for emulsified fluids that provide long term proppant suspension before fracture closure. The resulting clean break provides minimal formation and proppant pack damage.

Wellbore treatment fluids according to this disclosure comprise an aqueous phase comprising an aqueous base fluid and an oil phase (oil base fluid) comprising an oleaginous fluid or hydrocarbon. In embodiments, the wellbore treatment fluid is water-based, and comprises an aqueous base fluid. In embodiments, the wellbore treatment fluid of this disclosure is an oil-external emulsion comprising an oil-external phase and an aqueous internal phase.

### Aqueous Base Fluid

As used herein, the term ‘aqueous fluid’ refers to a material comprising water or a water-miscible but oleaginous fluid-immiscible compound. Illustrative aqueous fluids suitable for use in embodiments of this disclosure include, for example, fresh water, sea water, a brine containing at least one dissolved organic or inorganic salt, a liquid containing water-miscible organic compounds, and the like.

The aqueous fluid or base fluid of the present embodiments can generally be from any source, provided that the fluids do not contain components that might adversely affect the stability and/or performance of the wellbore treatment fluids of the present disclosure. In various embodiments, the aqueous fluid can comprise fresh water, salt water, seawater, brine, or an aqueous salt solution. In some embodiments, the aqueous fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. In some embodiments, the aqueous base fluid can be a high density brine. As used herein, the term ‘high density brine’ refers to a brine that has a density of about 9.5-10 lbs/gal or greater (1.1 g/cm³-1.2 g/cm³ or greater).

### Oil Base Fluid

A wellbore treatment fluid of this disclosure comprises an oil phase. In embodiments, a wellbore treatment fluid according to this disclosure comprises an oil-external phase. The oil phase comprises an oleaginous fluid, which may include one or more hydrocarbon. As used herein, the term ‘oleaginous fluid’ refers to a material having the properties of an oil or like non-polar hydrophobic compound. Illustrative oleaginous fluids suitable for use in embodiments of this disclosure include, for example, (i) esters prepared from fatty acids and alcohols, or esters prepared from olefins and fatty acids or alcohols; (ii) linear alpha olefins, isomerized olefins having a straight chain, olefins having a branched structure, isomerized olefins having a cyclic structure, and olefin hydrocarbons; (iii) linear paraffins, branched paraffins, poly-branched paraffins, cyclic paraffins and isoparaffins; (iv) mineral oil hydrocarbons; (v) glyceride triesters including, for example, rapeseed oil, olive oil, canola oil, castor oil, coconut oil, corn oil, cottonseed oil, lard oil, linseed oil, neatsfoot oil, palm oil, peanut oil, perilla oil, rice bran oil, safflower oil, sardine oil, sesame oil, soybean oil and sunflower oil; (vi) naphthenic compounds (cyclic paraffin compounds having a formula of CₙH₂ₙ, where n is an integer ranging between about 5 and about 30); (vii) diesel; (viii) aliphatic ethers prepared from long chain alcohols; and (ix) aliphatic acetals, dialkylcarbonates, and mixtures thereof. As used herein, fatty acids and alcohols or long chain acids and alcohols refer to acids and alcohols containing about 6 to about 22 carbon atoms, or about 6 to about 18 carbon atoms, or about 6 to about 14 carbon atoms. In some embodiments, such fatty acids and alcohols have about 6 to about 22 carbon atoms comprising their main chain. One of ordinary skill in the art will recognize that the fatty acids and alcohols may also contain unsaturated linkages.

In embodiments, in a wellbore treatment fluid according to this disclosure, an oleaginous fluid external phase and an aqueous fluid internal phase are present in a ratio of less than about 50:50. This ratio is commonly stated as the oil-to-water ratio (OWR). That is, in the present embodiments, a wellbore treatment fluid having a 50:50 OWR comprises 50% oleaginous fluid external phase and 50% aqueous fluid internal phase. In embodiments, treatment fluid according to this disclosure have an OWR ranging between about 1:99 to about 35:65, including all sub-ranges therein between. In embodiments, treatment fluid of this disclosure have an OWR ranging between about 1:99 and about 10:90, including all sub-ranges therein between. In embodiments, the treatment fluids have an OWR of about 10:90 or less. In embodiments, the treatment fluids have an OWR of about 5:95 or less. One of ordinary skill in the art will recognize that lower OWRs can more readily form emulsions that are suitable for suspending sand and other proppants therein. However, one of ordinary skill in the art will also recognize that an OWR that is too low may prove overly viscous for downhole pumping.

In embodiments, an oil-external emulsion treatment fluid according to this disclosure comprises a less than conventional volume percentage of oil. For example, in embodiments, a wellbore treatment fluid according to this disclosure comprises from about 1 to about 10, from about 2 to about 9, or from about 3 to about 8 volume percent oil, based on the total volume of the treatment fluid. In embodiments, a wellbore treatment fluid according to this disclosure comprises less than or equal to about 30, 25, 20, 15, 10, 9, 8 7, 6, 5, 4, or 3 volume percent oil, based on the total volume of the treatment fluid.

### Demulsifiers

A demulsifier is used to break emulsions, meaning to separate the emulsion into two phases. In the oilfield, emulsions may be selected based on the type of fluid that needs to be broken such as an oil-in-water fluid or a water-in-oil fluid. The demulsifiers of the disclosure have slower reaction kinetics which invert and break the emulsion over a prolonged time, even at increased temperatures. Generally, the demulsifier should break the emulsion after at least about 1 hour of placing the fluid in the wellbore.

Several useful demulsifiers include a nonionic microemulsion, a cationic microemulsion, an anionic microemulsion, and combinations thereof. One useful demulsifier includes nonionic alkoxylates, terpene hydrocarbons, water, and isopropanol. In a preferred embodiment, the demulsifier has the following composition: nonionic alkoxylate blend about 36.4% w/w; terpene hydrocarbons about 22.1% w/w; water about 15% w/w; and isopropanol about 26.5 w/w.

Another useful demulsifier includes water, cyclic paraffin base oils; n-butanol; isopropanol; nonionic alcohol alkoxylate surfactants; tall oil fatty acid diethanolamines; and polyethoxylated hydroxyfatty acids.

Demulsifiers of the disclosure may be present in the amount of about 0.1 gal/1000 gal to about 100 gal/1000 gal of treatment fluid. A preferred range is about 5 gal/1000 gal to about 30 gal/1000 gal of treatment fluid. An additional preferred range is about 0.1 gal/1000 gal to about 10 gal/1000 gal of treatment fluid.

The demulsifiers of the present invention may be sold encapsulated or non-encapsulated surfactants. The encapsulated demulsifiers of the present invention may be made using known microencapsulation techniques.

The capsules of the present invention are preferably made from a degradable material that degrades when subjected to downhole conditions so as to release the chemical components that are contained in the chambers of the delivery capsules into the well bore. Such degradable materials may include degradable polymers. Such degradable materials may be capable of undergoing an irreversible degradation downhole. The term “irreversible” as used herein means that the degradable material, once degraded downhole, should not recrystallize or reconsolidate while downhole, e.g., the degradable material should degrade in situ but should not recrystallize or reconsolidate in situ. The terms “degradation” or “degradable” refer to both the two relatively extreme cases of hydrolytic degradation that the degradable material may undergo, i.e., heterogeneous (or bulk erosion) and homogeneous (or surface erosion), and any stage of degradation in between these two. This degradation can be a result, inter alia, of a chemical or thermal reaction or a reaction induced by radiation. One should be mindful that the degradability of a polymer depends at least in part on its backbone structure. For instance, the presence of hydrolyzable and/or oxidizable linkages in the backbone often yields a material that will degrade as described herein. The physical properties of degradable polymers depend on several factors such as the composition of the repeat units, flexibility of the chain, presence of polar groups, molecular mass, degree of branching, crystallinity, orientation, etc. For example, short-chain branches reduce the degree of crystallinity of polymers while long-chain branches lower the melt viscosity and impart, inter alia, elongational viscosity with tension-stiffening behavior. The properties of the material utilized can be further tailored by blending, and copolymerizing it with another polymer, or by a change in the macromolecular architecture (e.g., hyper-branched polymers, star-shaped, or dendrimers, etc.). The properties of any such suitable degradable polymers (e.g., hydrophobicity, hydrophilicity, rate of degradation, etc.) can be tailored by introducing select functional groups along the polymer chains. For example, poly(phenyllactide) will degrade at about ⅕ th of the rate of racemic poly(lactide) at a pH of 7.4 at 55° C. One of ordinary skill in the art with the benefit of this disclosure will be able to determine the appropriate degradable polymer to achieve the desired physical properties of the degradable polymeric material.

Suitable examples of degradable materials that may be used in accordance with the present invention include, but are not limited to, those described in the publication of Advances in Polymer Science, Vol. 157, entitled “Degradable Aliphatic Polyesters” and edited by A. C. Albertsson, pages 1-138. Examples include homopolymers, random, block, graft, and star- and hyper-branched aliphatic polyesters. Polycondensation reactions, ring-opening polymerizations, free radical polymerizations, anionic polymerizations, carbocationic polymerizations, coordinative ring-opening polymerizations, and any other suitable process may prepare such suitable polymers. Specific examples of suitable degradable materials include polysaccharides such as dextrans or celluloses; chitins; chitosans; liquid esters (e.g., triethyl citrate); proteins (e.g., gelatin); aliphatic polyesters; poly(lactides); poly(glycolides); poly(ε-caprolactones); poly(hydroxybutyrates); poly(anhydrides); aliphatic poly(carbonates); ortho esters, poly(orthoesters); poly(amino acids); polyethylene oxides); and poly(phosphazenes). Other suitable materials include heat-sealable materials, other thermoplastic materials, or those that may be dissolved with an appropriate solvent. Examples include hydroxy propyl methylcellulose, pectin, polyethylene oxide, polyvinyl alcohol, alginate, polycaprolactone, gelatinised starch-based materials, and the like. In one embodiment, hydroxy propyl methylcellulose (HPMC) is used.

### Proppants

One component of the oil-external emulsions of the disclosure include proppants. In some embodiments, the proppants may be an inert material, and may be sized (e.g., a suitable particle size distribution) based upon the characteristics of the void space to be placed in.

Materials suitable for proppant particulates may comprise any material comprising inorganic or plant-based materials suitable for use in subterranean operations. Suitable materials include, but are not limited to, sand; bauxite; ceramic materials; glass materials; nut shell pieces; cured resinous particulates comprising nut shell pieces; seed shell pieces; cured resinous particulates comprising seed shell pieces; fruit pit pieces; cured resinous particulates comprising fruit pit pieces, wood; hydrophobically modified proppant, inherently hydrophobic proppant, proppant with a hydrophobic coating, and combinations thereof. The mean proppant particulate size generally may range from about 2 mesh to about 400 mesh on the U.S. Sieve Series; however, in certain circumstances, other mean proppant particulate sizes may be desired and will be entirely suitable for practice of the embodiments disclosed herein. In particular embodiments, preferred mean proppant particulate size distribution ranges are one or more of 6/12, 8/16, 12/20, 16/30, 20/40, 30/50, 40/60, 40/70, or 50/70 mesh. It should be understood that the term “particulate,” as used herein, includes all known shapes of materials, including substantially spherical materials; fibrous materials; polygonal materials (such as cubic materials); and any combination thereof. In certain embodiments, the particulates may be present in the treatment fluids in an amount in the range of from an upper limit of about 30 pounds per gallon (“ppg”)(3600 kg/m³), 25 ppg (3000 kg/m³), 20 ppg (2400 kg/m³), 15 ppg (1800 kg/m³), and 10 ppg (1200 kg/m³) to a lower limit of about 0.5 ppg (60 kg/m³), 1 ppg (120 kg/m³), 2 ppg (240 kg/m³), 4 ppg (480 kg/m³), 6 ppg (720 kg/m³), 8 ppg (960 kg/m³), and 10 ppg (1200 kg/m³) by volume of the treatment fluids.

### Coated Proppants

As used herein, the term “coating,” and the like, does not imply any particular degree of coating on a particulate. In particular, the terms “coat” or “coating” do not imply 100% coverage by the coating on a particulate. It should be understood that the term “particulate,” as used in this disclosure, includes all known shapes of materials, including substantially spherical materials, fibrous materials, polygonal materials (such as cubic materials), and combinations thereof.

The proppant coating may be applied by many techniques. In one embodiment, the coating is applied by solution coating. In this process a coating solution is prepared by mixing coating into a solvent until a homogenous mixture is achieved. Proppant is added to solution, and the solvent is removed under vacuum using a rotary evaporator. The remaining coating is adsorbed to proppant surface.

In an embodiment, a spray coating technique is used. Liquid coating is sprayed onto the proppant substrate. The coated proppant is then dried to remove water or carrier fluids.

In various embodiments, the amount of coating on the proppants is about 0.1 wt. % to about 10 wt. % of the proppant substrate.

### Emulsifiers

The water-in-oil emulsion of the treatment fluid of the present disclosure further comprises an emulsifier. As used herein, an “emulsifier” refers to a type of surfactant that helps prevent the droplets of the dispersed phase of an emulsion from flocculating or coalescing in the emulsion. Examples of emulsifiers that may be suitable include, but are not limited to, emulsifiers with an HLB (Davies' scale) in the range of about 4 to about 12.

Examples of suitable emulsifiers may include, but are not limited to, surfactants, proteins, hydrolyzed proteins, lipids, glycolipids, nanosized particulates (e.g., fumed silica), and combinations thereof. The emulisifier may be a polyaminated fatty acid.

An emulsifier or emulsifier package is preferably in a concentration of at least 0.1% by weight of the emulsion. More preferably, the emulsifier is in a concentration in the range of 0.1% to 10% by weight of the emulsion.

### Other Additives

In addition to the foregoing materials, it can also be desirable, in some embodiments, for other components to be present in the treatment fluid. Such additional components can include, without limitation, surfactants, gelling agents, fluid loss control agents, corrosion inhibitors, rheology control modifiers or thinners, viscosity enhancers, temporary viscosifying agents, filtration control additives, high temperature/high pressure control additives, emulsification additives, surfactants, acids, alkalinity agents, pH buffers, fluorides, gases, nitrogen, carbon dioxide, surface modifying agents, tackifying agents, foamers, scale inhibitors, catalysts, clay control agents, biocides, bactericides, friction reducers, antifoam agents, bridging agents, dispersants, flocculants, H₂S scavengers, CO₂ scavengers, oxygen scavengers, friction reducers, breakers, relative permeability modifiers, resins, wetting agents, coating enhancement agents, filter cake removal agents, surfactants, defoamers, shale stabilizers, oils, and the like. One or more of these additives (e.g., bridging agents) may comprise degradable materials that are capable of undergoing irreversible degradation downhole. A person skilled in the art, with the benefit of this disclosure, will recognize the types of additives that may be included in the fluids of the present disclosure for a particular application, without undue experimentation.

### Methods of Use

The methods of the present invention may be employed in any subterranean treatment where a viscoelastic treatment fluid may be used. Suitable subterranean treatments may include, but are not limited to, drilling, fracturing treatments, sand control treatments (e.g., gravel packing), and other suitable treatments where a treatment fluid of the present invention may be suitable.

A method of treating a fracture in a subterranean formation may include combining a demuslifier; proppant; an emulsifier; an oil base fluid; and aqueous base fluid to form an oil-external emulsified fluid; and placing the emulsified fluid into the subterranean formation. The breaking may occur at a time of greater than about 1 hour after placing the fluid in the wellbore. The breaking time may also occur after about 2, 3, 4, 5, 6, 7, 8, 9, 10, 11, 12, 13, 14, 15, 26, 17, 18, 19, 20, 21, 22 23, 24, 30, 36, 42, or 48 hours after placing the fluid in the wellbore.

A method of treating a fracture in a subterranean formation may include combining a demuslifier; an emulsifier; an oil base fluid; and aqueous base fluid to form an oil-external emulsified fluid; and placing at least a portion of the emulsified fluid into the subterranean formation as a pad fluid.

A method of treating in a subterranean formation may include introducing a pad fluid comprising a demulsifier into the subterranean formation; introducing an oil-external emulsified fluid into the subterranean formation after introducing the pad fluid, wherein the oil-external emulsified fluid comprises: an emulsifier; an oil base fluid; and aqueous base fluid; and contacting the pad fluid with the oil-external emulsified fluid.

In some embodiments, the present treatment fluids can be used in a subterranean formation having a temperature of up to about 350° F. In some embodiments, the present treatment fluids can be used in a subterranean formation having a temperature of up to about 320° F. In some embodiments, the present treatment fluids can be used in a subterranean formation having a temperature ranging between about 175° F. and about 350° F. In some embodiments, the present treatment fluids can be used in a subterranean formation having a temperature ranging between about 200° F. and about 350° F. In some embodiments, the present treatment fluids can be used in a subterranean formation having a temperature ranging between about 250° F. and about 350° F. In some embodiments, the present treatment fluids can be used in a subterranean formation having a temperature ranging between about 275° F. and about 350° F. In some embodiments, the present treatment fluids can be used in a subterranean formation having a temperature ranging between about 300° F. and about 350° F. In some embodiments, the present treatment fluids can be used in a subterranean formation having a temperature ranging between about 320° F. and about 350° F.

In some embodiments, emulsions made by the present invention can keep their integrity for at least about 2 days when used in a subterranean formation having a temperature of up to about 200° F. In certain embodiments, emulsions made by the present invention can keep their integrity for at least about 1 day when used in a subterranean formation having a temperature of up to about 200° F. In various embodiments, emulsions made by the present invention break after at least about 2 days when used in a subterranean formation having a temperature of up to about 200° F. In some embodiments, emulsions made by the present invention break after at least about 1 day when used in a subterranean formation having a temperature of up to about 200° F.

In some subterranean operations, it can be desirable to leave the emulsions in the subterranean formation for a shorter length of time. In some embodiments, emulsions formed from present treatment fluids can be allowed to remain in the subterranean formation for less than about one day. For example, the gels can be allowed to remain in the subterranean formation for at least about 16 hours, or at least about 14 hours, or at least about 12 hours, or at least about 10 hours, or at least about 8 hours, or at least about 6 hours, or at least about 4 hours, or at least about 2 hours before being broken.

Another method of treating a fracture in a subterranean formation includes combining proppant; a demulsifier; an aqueous base fluid, an oil base fluid, and an emulsifier to form a pre-emulsified fluid; mixing the pre-emulsified fluid to form an oil-external emulsified fluid, and placing the oil-external emulsified fluid into the subterranean formation.

The method of forming oil external emulsion according to this disclosure may include combining a proppant with an oil to provide an oil-coated proppant; combining the oil-coated proppant with an emulsifier, demulsifier and water; and agitating to form an oil external emulsion. In embodiments, it may be advantageous to combine the oil-coated proppant with the emulsifier, demulsifier and water substantially immediately subsequent to combining the proppant with the oil to provide the oil-coated proppant. Generally, the formation of the emulsion will occur within a few seconds.

The treatment fluids of the present invention may be prepared by any method suitable for a given application. For example, certain components of the treatment fluid of the present invention may be provided in a pre-blended powder or a dispersion of powder in a nonaqueous liquid, which may be combined with the aqueous base fluid at a subsequent time. After the preblended liquids and the aqueous base fluid have been combined other suitable additives may be added prior to introduction into the wellbore. Those of ordinary skill in the art, with the benefit of this disclosure will be able to determine other suitable methods for the preparation of the treatments fluids of the present invention.

In an exemplary embodiment, a method of forming a wellbore fluid includes combining proppant; a demulsifier; an aqueous base fluid, an oil base fluid, and an emulsifier to form a pre-emulsified fluid; and mixing the pre-emulsified fluid to form an oil-external emulsified fluid.

In still another exemplary embodiment, the separate introduction of at least two of the treatment fluid components may be achieved by introducing the components within a single flowpath, but being separated by a spacer. Such a spacer may comprise a highly viscous fluid which substantially or entirely prevents the intermingling of the treatment fluid components while being pumped into a wellbore. Such spacers and methods of using the same are generally known to those of ordinary skill in the art.

In addition to the fracturing fluid, other fluids used in servicing a wellbore may also be lost to the subterranean formation while circulating the fluids in the wellbore. In particular, the fluids may enter the subterranean formation via lost circulation zones for example, depleted zones, zones of relatively low pressure, zones having naturally occurring fractures, weak zones having fracture gradients exceeded by the hydrostatic pressure of the drilling fluid, and so forth.

In various embodiments, systems configured for delivering the treatment fluids described herein to a downhole location are described. In various embodiments, the systems can comprise a pump fluidly coupled to a tubular, the tubular containing the treatment fluids disclosed herein.

A wellbore treatment system may include an apparatus including a pump and a mixer to combine proppant; a demulsifier; an aqueous base fluid, an oil base fluid, and an emulsifier to form a pre-emulsified fluid; mix the pre-emulsified fluid to form an oil-external emulsified fluid; and introduce the treatment fluid into a subterranean formation.

In various embodiments, systems configured for delivering the treatment fluids described herein to a downhole location are described. In various embodiments, the systems can comprise a pump fluidly coupled to a tubular, the tubular containing the treatment fluids disclosed herein.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of the treatment fluid before it reaches the high pressure pump.

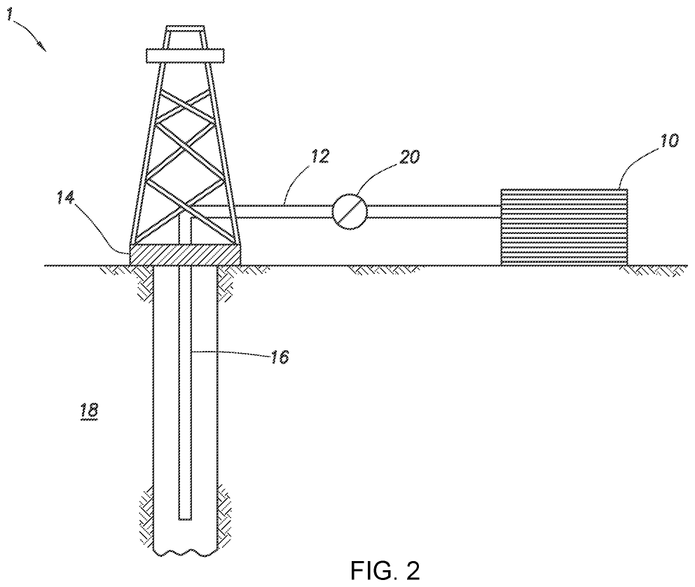

In embodiments, the disclosed wellbore treatment fluid may be prepared at a well site or at an offsite location. Once prepared, a treatment fluid of the present disclosure may be placed in a tank, bin, or other container for storage and/or transport to the site where it is to be used. In other embodiments, a treatment fluid of the present disclosure may be prepared on-site, for example, using continuous mixing, on-the-fly mixing, or real-time mixing methods. In certain embodiments, these methods of mixing may include methods of combining two or more components wherein a flowing stream of one element is continuously introduced into flowing stream of another component so that the streams are combined and mixed while continuing to flow as a single stream as part of the on-going treatment. The system depicted in FIG. 2 (described further below) may be one embodiment of a system and equipment used to accomplish on-the-fly or real-time mixing.

In some embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

FIG. 2 shows an illustrative schematic of a system that can deliver treatment fluids of the embodiments disclosed herein to a downhole location, according to one or more embodiments. It should be noted that while FIG. 2 generally depicts a land-based system, it is to be recognized that like systems may be operated in subsea locations as well. As depicted in FIG. 2, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 2 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 2, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 2.

The invention having been generally described, the following examples are given as particular embodiments of the invention and to demonstrate the practice and advantages hereof. It is understood that the examples are given by way of illustration and are not intended to limit the specification or the claims to follow in any manner.

### EXAMPLES

### Emulsion Formation and Stability

### Compositions

UNIFRAC™ 20/40 hydraulic fracturing sand has a size in the range of from 20 mesh to 40 mesh available from Unimin Corporation—Energy Division, Woodlands, Tex.
ESCAID 110™ oil is a light hydrotreated petroleum distillate/mineral oil, available from ExxonMobil Chemical Company, Spring, Tex.
EZ MUL NT™ emulsifier is a polyaminated fatty acid available from Halliburton Energy Services, Houston, Tex.
OILPERM A through F ™ components are demulsifiers available from Halliburton Energy Services, Inc., Houston, Tex.
OILPERM FMM2 ™ product is a cationic formation fluid mobility modifier available from Halliburton Energy Services, Inc., Houston, Tex.
OILPERM FFM3™ product is a non-ionic formation fluid mobility modifier available from Halliburton Energy Services, Inc., Houston, Tex.
HYBOR G™ fluid is a high viscosity fracturing fluid available from Halliburton Energy Services, Inc., Houston, Tex.
WG-36™ agent is a guar based gelling agent available from Halliburton Energy Services, Inc., Houston, Tex.
CL-31™ crosslinker, a non-delayed crosslinker, and CL-22UC™ crosslinker are both available from Halliburton Energy Services, Inc., Houston, Tex.

### Experimental Procedure

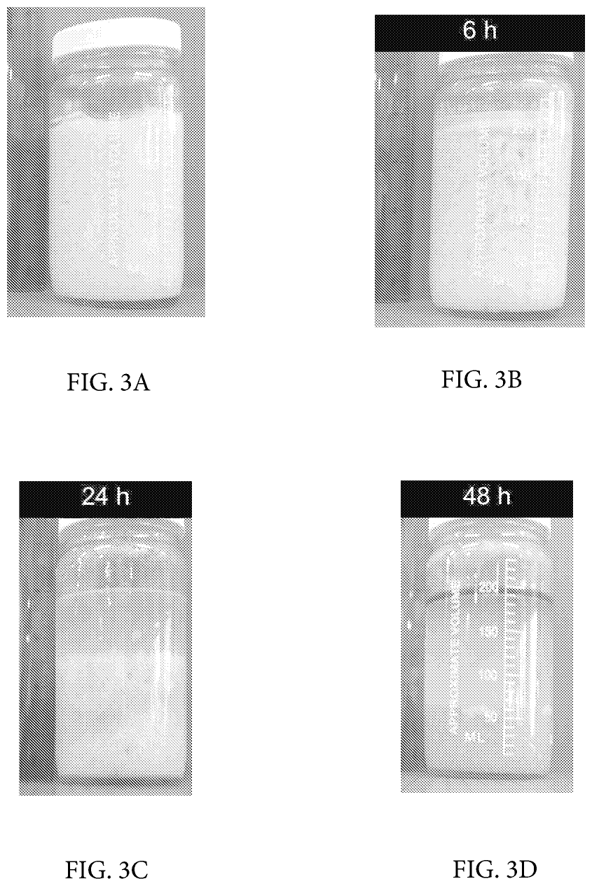

1. Emulsified Fluid Composition
A. Blend 1:20 oil/water, 10 gal/1000 gal EZ MUL NT™, 6 lb/gal UNIFRAC™ 20/40 sand, and 0.5 gal/1000 gal of demulsifier (OILPERM B™ used in FIGS. 3A-D fluids).
Make comparison fluid by blending 35 lb/1000 gal of WG-36 and 0.5 gal/1000 gal CL-31™ crosslinker, and 0.9 gal/1000 gal CL-22UC™ crosslinker at pH 11 (No breaker present).
B. Heat to 200° F. (93° C.).
C. Observe the amount of breaking of the fluids over time

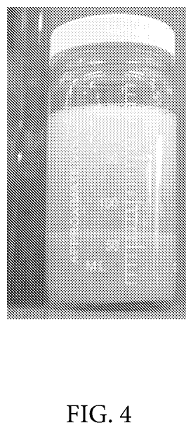

As seen in FIG. 3A, the emulsion with the demulsifier (OILPERM B™) forms a good emulsion fluid. The photograph in FIG. 3B was taken six hours later and shows only a slight breaking of the emulsion. The photograph in FIG. 3C shows that about 50% of the emulsion has been broken after 24 hours. After 48 hours, as shown in the photograph in FIG. 3D, the emulsion has completely broken. The comparison fluid, HYBOR G™ fluid without a breaker, failed to suspend the proppant beyond 1 hour at 200° F. (93° C.) as demonstrated in the photograph shown in FIG. 4.

Several other emulsifiers were tested in a similar way to the method disclosed above. The results are as follows:

OILPERM A™ and F™ demulsifier—unable to form emulsion

OILPERM FMM2™ cationic formation fluid mobility modifier—broke emulsion in less than 30 minutes

OILPERM C™, D™, E™ demulsifier—unable to break emulsion

2. Order of Mixing Test

The breaking ability of various demulsifiers was checked when the demulsifier was added while preparing the emulsion versus after the emulsion has been formed. Table 1 illustrates the breaking time for the emulsion when the demulsifier was added after the emulsion was formed.

EFT=the emulsion formation time.

gpt=gallons per 1000 gals

TABLE 1

| | EFT | | | | | | | | | |
|---|---|---|---|---|---|---|---|---|---|---|
| Breaker | (sec) | 1 h | 2 h | 3 h | 4 h | 5 h | 6 h | 16 h | 24 h | 68 h |
| 1 gpt | 150 | 1-2 mL liquid | | | | | | | | |
| OilPerm C | | | | | | | | | | |
| 1 gpt | | | | | | | | | | |
| OilPerm D | | | | | | | | | | |
| 1 gpt | | | | | | | | | | |
| OilPerm E | | | | | | | | | | |
| 1 gpt | | | | | | | | | | |
| OilPerm F | | | | | | | | | | |
| 1 gpt | | 1-2 mL | 2-4 mL | 5-7 mL liquid | | | 10-12 mL liquid | | 15-17 mL | 36 mL |
| OilPerm | | liquid | liquid | | | | | | liquid | liquid |
| FMM2 | | | | | | | | | | |
| 1 gpt | | | 4-6 mL liquid | | 8-10 mL liquid | | | | | |
| OilPerm B | | | | | | | | | | |
| 0.5 gpt | | None | 4-6 mL | 4-6 mL | | | | | | |
| OilPerm B | | | | | | | | | | |
| 0.5 gpt | | 2-5 mL | 2-5 mL | 3-5 mL | | | | | | |
| OilPerm | | | | | | | | | | |
| FMM2 | | | | | | | | | | |
| 0.5 gpt | | 35 mL | 40 mL | 40 mL | | | | | | |
| OilPerm | | | | | | | | | | |
| FMM3 | | | | | | | | | | |
| 1 gpt | | | | | | | | | | |
| OilPerm | | | | | | | | | | |
| FMM3 | | | | | | | | | | |

Table 2 illustrates the breaking time for the emulsion when the demulsifier was added during the emulsion formation. Water elimination was observed and recorded with respect to time. 1 gal/1000 gal of OilPerm FMM2™ cationic formation fluid mobility modifier provided controlled break. The rest of the breakers mentioned in Table 1 failed to either slowly break the emulsion or did not break the emulsion completely. Breaking the emulsified fluid system by the addition of a de-emulsifier to pre-prepared emulsion fluid was also evaluated, leading to the identification of additional breaker options by changing the breaker addition sequence.

TABLE 2

| | EFT | | | | | | | | | | |
|---|---|---|---|---|---|---|---|---|---|---|---|
| Breaker | (sec) | 30 min | 1 h | 2 h | 3 h | 4 h | 5 h | 16 h | 24 h | 42 h | 68 h |
| 1 gpt | 110 | 1-2 mL liquid | | | | | 2-4 mL liquid | | | | |
| OilPerm C | | | | | | | | | | | |
| 1 gpt | 180 | | | | | | | | | | |
| OilPerm E | | | | | | | | | | | |

| | | | |
|---|---|---|---|
| 1 gpt | 170 | 5-8 mL liquid | 6-7 mL liquid |
| OilPerm D | | | |

| | | | | | |
|---|---|---|---|---|---|
| 0.25 gpt | 600 | None | 2-5 mL | 15-17 ml | 15-17 ml |
| OilPerm B | | | | | |

| | | | | | |
|---|---|---|---|---|---|
| 1 gpt | 420* | Broke: | 30 mL | 40 mL | 40 mL liquid |
| OilPerm | | 20 mL | liquid | liquid | |
| FMM2 | | liquid | | | |

One of skill in the art may conclude that premixing the demulsifier with the emulsion fluid components is preferred because the resulting emulsion has greater delayed breaking times.

Embodiments disclosed herein include:

A: A method of treating in a subterranean formation comprising: combining a demulsifier; proppant; an emulsifier; an oil base fluid; and aqueous base fluid to form an oil-external emulsified fluid; and introducing the oil-external emulsified fluid into the subterranean formation.

B: A method of forming a wellbore fluid comprising: combining proppant; a demulsifier; an aqueous base fluid, an oil base fluid, and an emulsifier to form a pre-emulsified fluid; and mixing the pre-emulsified fluid to form an oil-external emulsified fluid.

C: A well treatment fluid comprising: an oil-external emulsified fluid comprising: a demulsifier; proppant; an emulsifier; an oil base fluid; and an aqueous base fluid.

D: A method of treating in a subterranean formation comprising: introducing a pad fluid comprising a demulsifier into the subterranean formation; introducing an oil-external emulsified fluid into the subterranean formation after introducing the pad fluid, wherein the oil-external emulsified fluid comprises: an emulsifier; an oil base fluid; and aqueous base fluid; and contacting the pad fluid with the oil-external emulsified fluid.

E: A well treatment system comprising: a well treatment apparatus, including a mixer and a pump to: combine proppant; a demulsifier; an aqueous base fluid, an oil base fluid, and an emulsifier to form a pre-emulsified fluid; mix the pre-emulsified fluid to form an oil-external emulsified fluid; and introduce the oil-external emulsified fluid into a subterranean formation.

Each of embodiments A, B, C, D, and E may have one or more of the following additional elements in any combination: Element 1: wherein the combining further comprises a proppant. Element 2: wherein the demulsifier comprises a nonionic microemulsion, a cationic microemulsion, an anionic microemulsion, and combinations thereof. Element 3: wherein the demulsifier comprises nonionic alkoxylates, terpene hydrocarbons, water, and isopropanol. Element 4: wherein the demulsifier comprises water, cyclic paraffin base oils; n-butanol; isopropanol; nonionic alcohol alkoxylate surfactants; tall oil fatty acid diethanolamines; and polyethoxylated hydroxyfatty acids. Element 5: wherein the demulsifier comprises at least one of a solid encapsulated surfactant, solid non-encapsulated surfactant, and combinations thereof. Element 6: wherein the demulsifier is present in the amount of about 0.1 to about 10 gal/1000 gal. Element 7: wherein the oil-external fluid breaks after at least about one hour. Element 8: wherein the oil base fluid comprises at least one of esters prepared from fatty acids and alcohols; esters prepared from olefins and fatty acids; esters prepared from olefins and alcohols; linear alpha olefins; isomerized olefins having a straight chain; olefins having a branched structure; isomerized olefins having a cyclic structure; olefin hydrocarbons; linear paraffins; branched paraffins; poly-branched paraffins; cyclic paraffins; isoparaffins; mineral oil hydrocarbons; glyceride triesters; naphthenic compounds; diesel; aliphatic ethers prepared from long chain alcohols; aliphatic acetals; dialkylcarbonates; and combinations thereof. Element 9: wherein the proppants are at least one selected from the group consisting of sand; bauxite; ceramic materials; glass materials; polymer materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; hydrophobically modified proppants, inherently hydrophobic proppants, proppants with a hydrophobic coating; and any combination thereof. Element 10: wherein the combining further comprises a proppant, wherein the subterranean formation comprises at least one fracture and wherein the introducing further comprises placing at least a portion of the oil-external fluid into the at least one fracture. Element 11: further comprising breaking the introduced oil-external emulsified fluid without the use of an external breaker. Element 12: wherein the oil-external emulsified fluid has an oil-to-water ratio of about 1:99 to about 35:65. Element 13: wherein the introducing further comprises placing at least a portion of the oil-external fluid into the subterranean formation as a pad fluid. Element 14: wherein the proppant is coated with the demulsifier to form a coated proppant before combining the resulting coated proppant with the aqueous base fluid, the oil base fluid, and the emulsifier. Element 15: wherein at least a portion of the demulsifier is present as a coating on the proppant.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method of treating in a subterranean formation comprising:
combining a demulsifier; an emulsifier; an oil base fluid; and aqueous base fluid to form an oil-external emulsified fluid; and
introducing the oil-external emulsified fluid into the subterranean formation.

2. The method of claim 1, wherein the combining further comprises a proppant.

3. The method of claim 1, wherein the demulsifier comprises a nonionic microemulsion, a cationic microemulsion, an anionic microemulsion, and combinations thereof.

4. The method of claim 3, wherein the demulsifier comprises at least one of nonionic alkoxylates, terpene hydrocarbons, water, isopropanol, cyclic paraffin base oils, n-butanol, isopropanol, nonionic alcohol alkoxylate surfactants, tall oil fatty acid diethanolamines, or polyethoxylated hydroxyfatty acids.

5. (canceled)

6. The method of claim 1, wherein the demulsifier comprises at least one of a solid encapsulated surfactant, solid non-encapsulated surfactant, and combinations thereof.

7. The method of claim 1, wherein the demulsifier is present in the amount of about 0.1 to about 10 gal/1000 gal and wherein the oil-external emulsified fluid has an oil-to-water ratio of about 1:99 to about 35:65..

8. The method of claim 1, wherein the oil-external fluid breaks after at least about one hour.

9. The method of claim 1, wherein the oil base fluid comprises at least one of esters prepared from fatty acids and alcohols; esters prepared from olefins and fatty acids; esters prepared from olefins and alcohols; linear alpha olefins; isomerized olefins having a straight chain; olefins having a branched structure; isomerized olefins having a cyclic structure; olefin hydrocarbons; linear paraffins; branched paraffins; poly-branched paraffins; cyclic paraffins; isoparaffins; mineral oil hydrocarbons; glyceride triesters; naphthenic compounds; diesel; aliphatic ethers prepared from long chain alcohols; aliphatic acetals; dialkylcarbonates; and combinations thereof.

10. The method of claim 2, wherein the proppants are at least one selected from the group consisting of sand; bauxite; ceramic materials; glass materials; polymer materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; hydrophobically modified proppants, inherently hydrophobic proppants, proppants with a hydrophobic coating; and any combination thereof.

11. The method of claim 1, wherein the combining further comprises a proppant, wherein the subterranean formation comprises at least one fracture and wherein the introducing further comprises placing at least a portion of the oil-external fluid into the at least one fracture.

12. The method of claim 1, further comprising breaking the introduced oil-external emulsified fluid without the use of an external breaker.

13. (canceled)

14. The method of claim 1, wherein the introducing further comprises placing at least a portion of the oil-external fluid into the subterranean formation as a pad fluid.

15. A method of forming a wellbore fluid comprising:
combining proppant; a demulsifier; an aqueous base fluid, an oil base fluid, and an emulsifier to form a pre-emulsified fluid; and
mixing the pre-emulsified fluid to form an oil-external emulsified fluid.

16. The method of claim 15, wherein the proppant is coated with the demulsifier to form a coated proppant before combining the resulting coated proppant with the aqueous base fluid, the oil base fluid, and the emulsifier.

17. The method of claim 15, wherein the demulsifier comprises a nonionic microemulsion, a cationic microemulsion, an anionic microemulsion, and combinations thereof.

18. The method of claim 17, wherein the demulsifier comprises at least one of nonionic alkoxylates, terpene hydrocarbons, water, isopropanol, cyclic paraffin base oils, n-butanol, nonionic alcohol alkoxylate surfactants, tall oil fatty acid diethanolamines, or polyethoxylated hydroxyfatty acids.

19. (canceled)

20. The method of claim 15, wherein the demulsifier is present in the amount of about 0.1 to about 10 gal/1000 gal and wherein the oil-external emulsified fluid has an oil-to-water ratio of about 1:99 to about 35:65.

21. (canceled)

22. The method of claim 15, wherein the oil base fluid comprises at least one of esters prepared from fatty acids and alcohols; esters prepared from olefins and fatty acids; esters prepared from olefins and alcohols; linear alpha olefins; isomerized olefins having a straight chain; olefins having a branched structure; isomerized olefins having a cyclic structure; olefin hydrocarbons; linear paraffins; branched paraffins; poly-branched paraffins; cyclic paraffins; isoparaffins; mineral oil hydrocarbons; glyceride triesters; naphthenic compounds; diesel; aliphatic ethers prepared from long chain alcohols; aliphatic acetals; dialkylcarbonates; and combinations thereof.

23. The method of claim 15, wherein the proppants are at least one selected from the group consisting of sand; bauxite; ceramic materials; glass materials; polymer materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; hydrophobically modified proppants, inherently hydrophobic proppants, proppants with a hydrophobic coating; and any combination thereof.

24-32. (canceled)

31. A method of treating in a subterranean formation comprising:
introducing a pad fluid comprising a demulsifier into the subterranean formation; introducing an oil-external emulsified fluid into the subterranean formation after introducing the pad fluid, wherein the oil-external emulsified fluid comprises: an emulsifier; an oil base fluid; and aqueous base fluid; and
contacting the pad fluid with the oil-external emulsified fluid.

32. (canceled)
